(19) United States
(12) Patent Application Publication
(10) Pub. No.: US 2007/0234656 A1
(43) Pub. Date: Oct. 11, 2007

(54) Hurricane Window Cover

(76) Inventor: Benn Leonard Framer, Midvale, UT (US)

Correspondence Address: PATREA L. PABST;PABST PATENT GROUP LLP, 400 COLONY SQUARE, SUITE 1200, 1201 PEACHTREE STREET, ATLANTA, GA, 30361, US

(21) Appl. No.: 11/534,584

(22) Filed: Sep. 22, 2006

Related U.S. Application Data
(60) Provisional application No. 60/719,731, filed on Sep. 22, 2005.

(51) Int. Cl. E06B 3/00

(52) U.S. Cl. 52/204.5

(57) ABSTRACT

A protective cover for windows and kits containing a protective covering for windows are described herein. The protective cover is formed of rubber, preferably formed from recycled tires. The cover may be rolled up to form a cylinder and then unrolled to cover the window or door. The kit contains a pre-sized protective cover and means for securing the cover to a building. Means for securing the cover to a building include screws and washers, bolts, nails, brackets, latches, a sleeve, a buildout frame, and manual or motorized rolling devices. In one preferred embodiment, the kit contains a cover contain with at least four holes, where each hole contains a grommet, and plates, screws and washers, bolts, nails, brackets, and/or latches to attach the cover to the building. In one preferred embodiment, the kit contains a sleeve and a cover. The sleeve can be secured to the outside of a window frame on both sides of and below the window to be protected and the cover can slidably engage with the sleeve. In another preferred embodiment, the kit contains a buildout frame, in unassembled or assembled form, a cover, a suitable number of metal plates containing more than one hold, and screws, or other suitable means for attachment.

### CROSS-REFERENCE TO RELATED APPLICATIONS

This application claims priority to U.S. Ser. No. 60/719,731 entitled “Hurricane Window Cover”, by Benn L. Framer, filed Sep. 22, 2005.

### FIELD OF THE INVENTION

The present application is directed to the field of protective coverings for windows and doors during severe storms, such as hurricanes.

### BACKGROUND OF THE INVENTION

During severe storms, such as hurricanes, most of the damage to a building results from wind or wind-borne missiles that break windows and allow rain and wind into the building. Once the wind is inside a building, the resulting pressure can even lift the roof off of the building. Temporary coverings are often placed over windows to reduce or prevent damage to the building during a hurricane.

During hurricane warnings, homeowners often nail plywood over windows and glass doors to prevent wind-driven rain and debris from breaking the window and entering the house. Although plywood is an inexpensive material, it is difficult to nail to a home quickly. Nailing sheets of plywood to a home is time-consuming and cumbersome due to the weight of the material, and the need for assistance. Homeowners are often reluctant to drive nails into their window frames or do not want to be on a ladder during high winds. In addition, usually more than one person as individual cannot hold up a large, heavy piece of plywood and nail it in at the same time. Further, strong winds often rip nailed plywood off of a window frame, and rain and winds warp the plywood so that it cannot be reused after a storm.

A number of protective coverings have been designed. U.S. Pat. No. 6,205,713 to Thompson et al. describes a shutter system which includes brackets above or below a window and sliding latches at the edges of the window. Transparent shutter systems are described in U.S. Pat. No. 4,685,261 to Seaquist and U.S. Pat. No. 5,228,238 to Fenkell. An accordion fold shutter system is described in U.S. Pat. No. 5,522,445 to Hoffman.

However, there remains a need for a cost-effective, easy-to-use protective covering for windows and glass doors that is highly resistant to impact breakage, especially, during the bombardment of debris or other air-borne projectiles during severe storms, such as hurricanes.

Therefore, it is an object of the invention to provide a cost-effective, easy to use cover protecting windows and glass doors during severe storms, such as hurricanes.

It is a further object of the invention to provide cost-effective and easy to use kits for protecting windows and glass doors during severe storms, such as hurricanes.

### BRIEF SUMMARY OF THE INVENTION

A protective cover for windows and kits containing a protective covering for windows are described herein. The protective cover is formed of rubber, preferably formed from recycled tires. The cover may be rolled up to form a cylinder and then unrolled to cover the window or door. The kit contains a pre-sized protective cover and means for securing the cover to a building. Means for securing the cover to a building include screws and washers, bolts, nails, brackets, latches, a sleeve, a buildout frame, and manual or motorized rolling devices. In one preferred embodiment, the kit contains a cover contain with at least four holes, where each hole contains a grommet, and plates, screws and washers, bolts, nails, brackets, and/or latches to attach the cover to the building. In one preferred embodiment, the kit contains a sleeve and a cover. The sleeve can be secured to the outside of a window frame on both sides of and below the window to be protected and the cover can slidably engage with the sleeve. In another preferred embodiment, the kit contains a buildout frame, in unassembled or assembled form, a cover, a suitable number of metal plates containing more than one hold, and screws, or other suitable means for attachment.

### BRIEF DESCRIPTION OF THE DRAWINGS

FIG. 1 is an illustration of the protective cover with four holes, one in each corner.

FIGS. 2A and 2B are illustrations of the protective cover slidably engaged with a sleeve in two different configurations.

FIG. 3 is an illustration of a fully assembled kit containing the protective cover, attachment bars with holes for screws, screws, and a buildout frame. In this embodiment, the protective cover is attached to all four sides of the sides of the frame using the attachment bars and screws.

FIG. 4 is an illustration of a fully assembled kit containing the protective cover, attachment bars with holes for screws, screws, and a buildout frame. In this embodiment, the protective cover is attached to three sides of the frame using the attachment bars and screws, and is slideably engaged with the frame on the remaining side.

### DETAILED DESCRIPTION OF THE INVENTION

A protective cover for windows and glass doors and kits containing a protective covering for windows and glass doors are described herein.

I. Protective Cover

The cover material is selected to withstand hurricane force winds of at least 110 miles per hour (mph). The protective cover is typically formed of rubber, preferably rubber manufactured from recycled tires. In the most preferred embodiment, the recycled rubber is molded to form the material for the cover. Preferably the material has an essentially uniform composition. In a preferred embodiment the material is rubber material sold under the tradename, Metal Mat™ (DODGE-REGUPOL®, Inc., Lancaster, Pa.).

According to the manufacturer, this material has the properties listed in Table 1.

TABLE 1
Metal Mat Properties

| Property | Test Method | Result | Units |
|---|---|---|---|
| Binder | ASTM D2000 | Co-polymer | N/A |
| Density | ASTM D297 | 0.93 min | g/cm³ |
| Tensile Strength - parallel | ASTM D412-Die C | 350 | PSI |
| to grain flow | | | |
| Tensile Strength - | ASTM D412-Die C | 400 | PSI |
| perpendicular to grain flow | | | |
| Elongation - | ASTM D412-Die C | 125 | Percent |
| parallel to grain flow | | | (%) |
| Elongation - perpendicular | ASTM D412-Die C | 125 | Percent |
| to grain flow | | | (%) |
| Durometer Hardness, A2 | ASTM D2240 | 60 ± 5 | Points |
| Tear Strength - | ASTM D624 - | 100 | PPI |
| parallel to grain flow | Die C | | |
| Tear Strength - | ASTM D624 - | 110 | PPI |
| perpendicular to grain flow | Die C | | |
| Flexibility | ASTM F147 | 0 | Factor |
| Thickness | | 2 mm | mm |
| | | nominal | |
| Coefficient of Friction | ASTM D1894 | 1.25 | |

The cover typically has a thickness ranging from about ¼ inch to 1 inch, preferably the cover is has a thickness of at least ½ inch thick, preferably the thickness ranges from about ½ inch thick to about ⅝ thick.

The covering may be of any suitable shape, but typically it is in the form of a rectangle. The length and width are suitable to cover a window or sliding glass door. Typically, the cover is at least 2 inches longer and wider than the window or door it is designed to cover. Typically the height ranges from 2 feet to 8 feet. Generally, the width ranges from 2 feet to 4 feet. Typical dimensions include 2 feet by 2 feet, 2 feet to 3 feet, 4 feet by 4 feet, 4 feet by 7 feet and 4 feet by 8 feet, preferably the protective cover has dimensions of 4 feet by 4 feet or 4 feet by 8 feet. Typical dimensions for covers for windows are 4 feet by 4 feet. Typical dimensions for covers for sliding doors are 4 feet by 8 feet.

The dimensions and material for the cover are selected to form a cover that weighs as little as possible, while covering and protecting the window from winds of 110 mph or greater. Typically the cover weighs up to 60 lbs, for a cover for a sliding door, and up to 40 lbs for a cover for a window. Typically, covers for windows weigh from 20 lbs to 40 lbs. However, covers for large windows may weigh up to 60 lbs. Typically, covers for sliding doors weigh between 40 lbs and 60 lbs. Covers with the dimensions of 4 feet by 8 feet and ½ inch thick, typically weigh about 60 lbs. Covers with the dimension of 4 feet by 4 feet and ½ inch thick, typically weigh about 30 lbs.

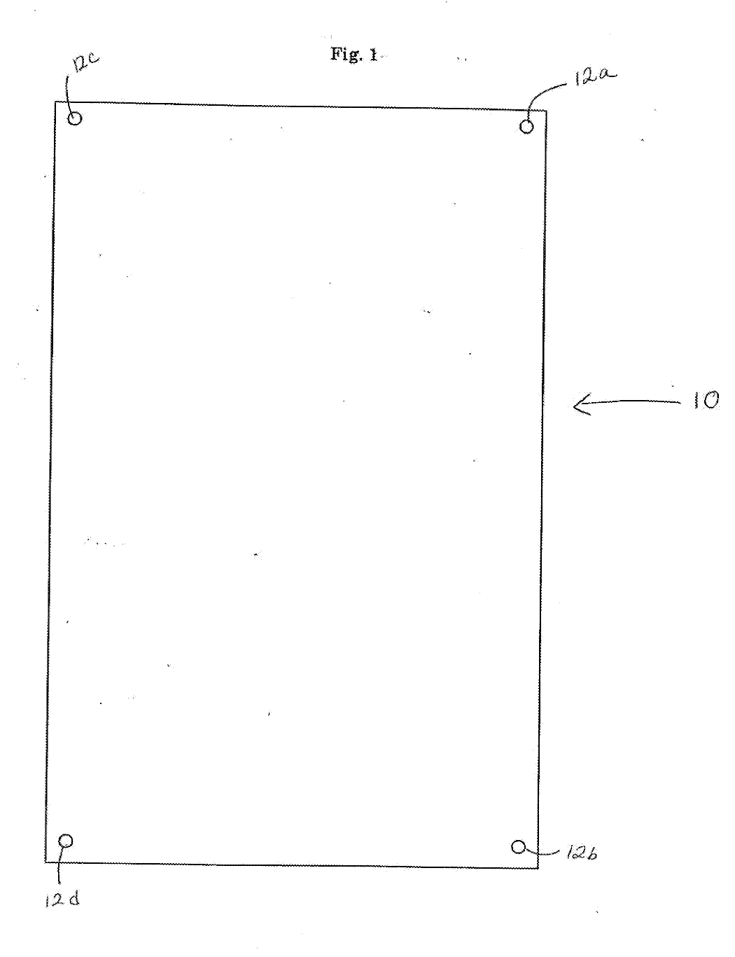

Preferably the cover contains one or more areas for attaching the cover to the building, a frame around the window, or a sleeve or buildout frame attached to the window. Optionally, the cover contains one or more holes through which the covering can be attached to the building, frame, sleeve or buildout frame. Optionally each hole contains a grommet. FIG. 1 illustrates a cover (10) containing four holes (12a, b, c, and d), with one hole in each corner of the cover. Optionally, the cover may contain additional holes, to allow for additional points of attaching the cover to the building.

II. Kits for Protective Cover

A kit containing a pre-sized protective cover and means for securing the cover to a building may be provided. Typically the kit contains four or more means for securing the cover to a building. Means for securing the cover to a building include plates or bars, screws and washers, bolts, nails, brackets, latches, a sleeve, a buildout frame, and manual or motorized rolling devices.

Brackets and latches designed for use during hurricane conditions are described in U.S. Pat. No. 6,363,670 to Dewitt and U.S. Pat. Nos. 6,131,354 and 6,207,713 to Thompson.

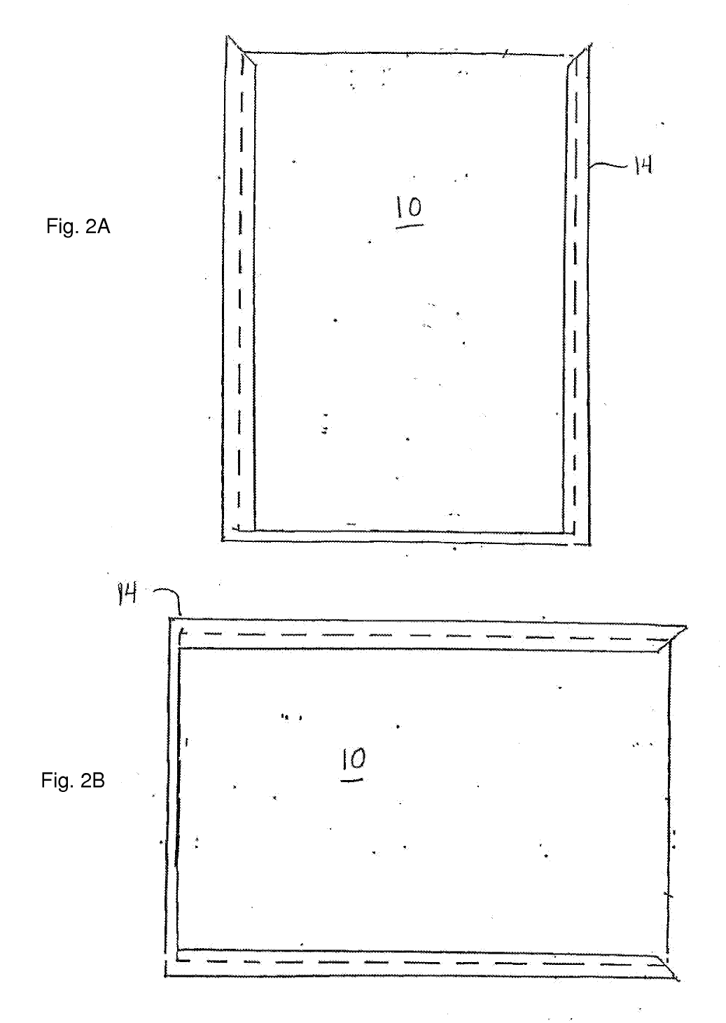

The sleeve typically contains three sides which are designed to be attached to the bottom and sides of a window or door frame, or to be attached one side and the top and bottom of the window or door frame (see FIGS. 2A and 2B). The sides of the sleeve are sized so that the cover (10) fits inside the sleeve (14). The sleeve is at least two inches wider and longer, and preferably is at least three inches wider and longer, than the window or door that requires covering.

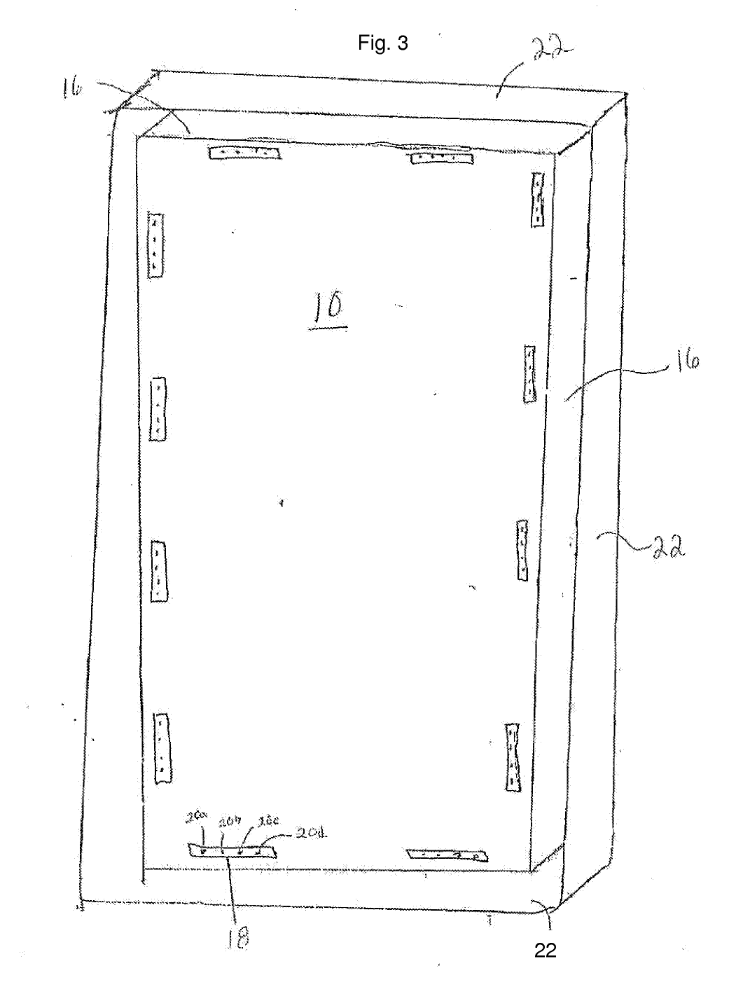

The buildout frame is designed to attach to the window or door frame. Typically, the buildout frame is formed of a sturdy, weather resistant material, such as metal. The buildout frame is designed to provide a gap of at least 3 inches, and preferably at least 6 inches, between the outer surface of the glass window or door and the protective covering. This gap allows for the cover the stretch and elongate when it is subjected to high speed winds, while providing protection for the window. As shown in FIG. 3, the buildout frame may be a metal frame (16) to which the cover (10) can be attached, such as by using metal bars (18) with one or more holes (20a, b, c, and d) and screws (not shown in figure). The buildout frame may be formed using metal strips or bars having dimensions of 2 inches by 6 inches by 6 feet, which is cut to the size of the window casing, and dimensions of 2 inches by 6 inches by 8 feet, which is cut to the size of the sliding door casing. As shown in FIG. 3, the buildout frame can attach to the frame (22) of the window or door.

In a preferred embodiment, the kit contains an unassembled or assembled buildout frame, a cover having dimensions of 4 feet by 4 feet or 4 feet by 8 feet, and a suitable number of metal plates with holes and screws. The unassembled buildout frame preferably contains four metal bars, preferably with dimensions of 2 inches by 6 inches and an appropriate length for the window or door to be covered (i.e. “cut to size”) and means for attachment to attach the metal bars to each other to form a rectangular frame. In another embodiment, the unassembled buildout frame preferably contains four metal bars, preferably with dimensions of 2 inches by 6 inches and a length of 6 feet for windows or 8 feet for sliding doors and means for attachment to attach the metal bars to each other to form a rectangular frame. In this embodiment, the user cuts the metal bars to size to fit over the window or door and then attaches the metal bars to each other to form a rectangular frame. Optionally, the cover may be sized to fit over the particular window or door requiring protection.

Preferably the kit contains means for attaching the cover to the window or door frame, buildout frame, or sleeve. Suitable means include plates or bars, clips, screws and washers, bolts, nails, brackets, and latches. In a preferred embodiment, the means for attachment include metal plates or bars containing one or more holes, preferably 2 or more holes, most preferably four holes. Preferably the metal plate or bar is 6 inches long. The holes in each metal plate or bar can be aligned with holes in cover along one or more edges of the cover, and a screw can be placed through both holes (in the cover and the metal plate or bar) to attach the cover to a sleeve, frame or the window casing.

III. Use of the Protective Cover

The protective cover may be placed on the frame of the window or door using suitable means for attaching the cover. Optionally, for large windows or doors, more than one cover may be used to cover the window. One cover may be connected to another cover by overlapping one hole in a first cover with a hole in the second cover and placing means for attachment (e.g. metal plates with holes, screws and/or washers) through the holes and attaching the two covers simultaneously to the frame of the window or door. Optionally, each hole contains a grommet.

In one embodiment, illustrated in FIGS. 2A and 2B, the cover is slidably engaged and mounted securely in a sleeve that is secured to the outside of the window frame on both sides of and below the window to be protected. As shown in FIG. 2A, the cover may slide into the sleeve from the top of the window to the bottom of the window. As shown in FIG. 2B, the cover may slide into the sleeve sideways, from one side of the window to the opposite side. The sleeve may be permanently secured to the outside of the window frame or it may be removable from the window frame.

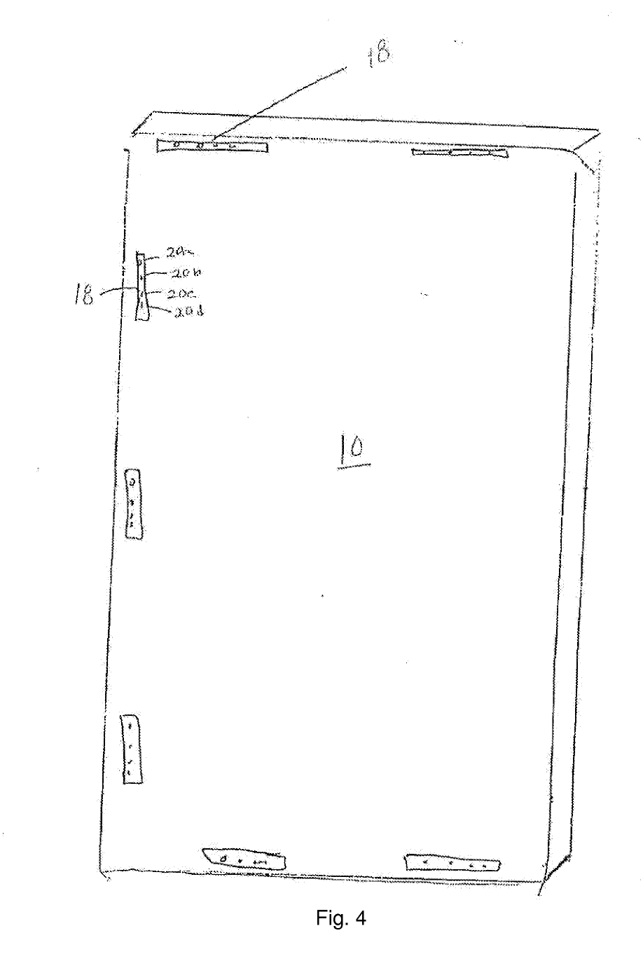

In another embodiment, illustrated in FIG. 4, the cover is slidably engaged with a sleeve and mounted securely to a window casing. As illustrated in FIG. 4, the cover is mounted securely on three sides of a window casing, using a flat metal plate containing multiple holes, in which screws are placed. As shown in FIG. 4, the metal plate (18) contains four holes (20a, b, c, and d). Metal plates are evenly spaced along the perimeter on three sides of the cover (10), such as every 6 inches to 12 inches.

In another embodiment, the cover is mounted on a roller device, which is permanently attached to the top of the window or door. The cover can be unrolled and secured using brackets or washers and screws when needed. The roller device may be manually operated or motorized. Optionally, a track is installed on both sides of the window to guide the cover as it is rolled over the window.

The present invention will be further understood by reference to the following non-limiting examples.

### EXAMPLE

A cover 4 feet wide and 4 feet long with ½ thickness was tested using two tests. The cover material was a rubber material sold under the tradename, Metal Mat™ (DODGE-REGUPOL®, Inc., Lancaster, Pa.). The first test was a missile impact test. The cover was attached to a window frame using multiple flat bars of metal with 4 holes. The metal bars were placed on each side of the square material, evenly spaced, with 10 inches between each metal bar. This arrangement secured the cover to each side of the window frame.

A “2-by-4” was shot at 110 mph from a distance 14 feet from the cover. The test was repeated four times. Each time, the 2-by-4 bounced off of the cover. The cover did not break under the force.

In contrast, when the 2-by-4 was shot at 110 mph from a distance of 14 feet from a cover formed of ½ inch thick plywood, the 2-by-4 broke the plywood.

The second test was the Standard Test Method for Structural Performance of Exterior Windows, Doors, Skylights and Curtain Walls by Uniform Static Air Pressure Difference (ASTM E 330). This is a standard test to assess the structural performance of exterior windows, doors, skylights, and curtain walls under uniform static air pressure differences (i.e. different wind loads), using a test chamber. In this test, the cover material, was a rubber material sold under the tradename, Metal Mat™ (DODGE-REGUPOL®, Inc., Lancaster, Pa.), was subjected to different forces under both positive and negative loads and the deflection of the material was measured. The test conditions and corresponding measured deflection when the material was subjected to a positive load are provided Table 2.

TABLE 2
Test Conditions and Deflection of
Cover Material under Positive Load

| Test Conditions | Deflection of Cover Material |
|---|---|
| (pounds per square foot) (psf) | (inches) |
| 50.0 | 1.125 |
| 60.0 | 2.000 |
| 70.0 | 2.250 |
| 80.0 | 2.500 |
| 90.0 | 2.625 |
| 100.0 | 2.875 |
| 120.0 | 3.125 |
| 140.0 | 3.375 |
| 150.0 | 3.625 |

The test conditions and corresponding measured deflection when the material was subjected to a negative load are provided Table 3.

TABLE 3
Test Conditions and Deflection of
Cover Material under Negative Load

| Test Conditions | Deflection of Cover Material |
|---|---|
| (pounds per square foot) (psf) | (inches) |
| 50.0 | 1.625 |
| 60.0 | 2.125 |
| 70.0 | 2.375 |
| 80.0 | 2.500 |
| 90.0 | 2.625 |
| 100.0 | 2.750 |
| 120.0 | 2.937 |
| 140.0 | 3.125 |
| 150.0 | 3.375 |

The material performed very well under high loads, which simulate the air pressure that pushes and pulls on a cover during a hurricane. Winds at speeds of 220 mph typically exert loads equivalent to 150 psf. At 150 psf, the material did not break, and elongated by only 3.375-3.625 inches. According to current Miami-Dade County codes, such materials are acceptable for use as hurricane covers.

Those skilled in the art will recognize, or be able to ascertain using no more than routine experimentation, many equivalents to the specific embodiments of the invention described herein. Such equivalents are intended to be encompassed by the following claims.

I claim:

1. A protective cover formed of a material manufactured from recycled tires, wherein the cover comprises one or more holes, wherein the material weighs less than 60 lbs, and wherein cover is sized to fit over a window or door.

2. The protective cover of claim 1, wherein the material weighs between about 30 lbs and 60 lbs.

3. The protective cover of claim 1, wherein the material has a thickness ranging from ¼ inch to 1 inch.

4. The protective cover of claim 3, wherein the material has a thickness ranging from ½ inch to ⅝ inch

4. The protective cover of claim 1 in the shape of a rectangle.

5. The protective cover of claim 4, wherein the cover has a length from 2 feet and to 4 feet and a height from 2 feet to 8 feet.

6. A kit comprising a protective cover and one or more means for securing the cover to a building, wherein the protective cover is formed of a material manufactured from recycled tires, wherein the material weighs less than 60 lbs, and wherein cover is sized to fit over a window or door or has dimensions of 4 feet by 4 feet or 4 feet by 8 feet.

7. The kit of claim 6, wherein the means for securing the cover are selected from the group consisting of screws and washers, bolts, nails, brackets, latches, a sleeve or frame, a buildout frame, and manual or motorized rolling devices.

8. The kit of claim 7, wherein the cover further comprises at least 4 holes and wherein the kit comprises at least 4 screws and washers.

9. The kit of claim 7, comprising a sleeve or frame for slidably attaching the cover to a building.

10. The kit of claim 7, wherein the sleeve or frame contains three sides which are suitable for attaching to the bottom and sides of a window or door frame and one or more means for attaching the top of the cover to the window or door.

11. The kit of claim 7, comprising a manual or motorized rolling device, and one or more means for attaching the bottom of the cover to the window or door.

12. The kit of claim 7, comprising a buildout frame.

13. The kit of claim 12, wherein the buildout frame is provided in unassembled form and comprises four metal bars at attachments for the bars.

14. The kit of claim 13, wherein the four metal bars have dimensions of 2 inches by 6 inches.

15. The kit of claim 12, further comprising more than one metal plate comprising multiple holes and screws sized to fit within the holes in the metal plate.

16. The kit of claim 12, wherein the cover has dimensions of 4 feet by 4 feet and ½ inch thickness.

17. The kit of claim 12, wherein the cover has dimensions of has dimensions of 4 feet by 8 feet and ½ inch thickness.

18. A method for protecting a window or door during a storm comprising attaching to the outside of the window or door frame a cover formed of a material manufactured from recycled tires, wherein the material weighs less than 60 lbs, and wherein cover is sized to fit over a window or door, with means for securing the cover selected from the group consisting of plates, screws and washers, bolts, nails, brackets, latches, a buildout frame, a sleeve or frame, and manual or motorized rolling devices.
